(19) United States
(12) Patent Application Publication
(10) Pub. No.: US 2016/0319959 A1
(43) Pub. Date: Nov. 3, 2016

(54) SUPPORT UNIT

(71) Applicant: COMPANY BLACK LLC, BEDFORD, PA (US)

(72) Inventor: William K. Pratt, BEDFORD, PA (US)

(21) Appl. No.: 15/208,088

(22) Filed: Jul. 12, 2016

Related U.S. Application Data
(63) Continuation-in-part of application No. 14/613,472, filed on Feb. 4, 2015, now Pat. No. 9,440,772.
Application No. 14/613,472 is a continuation-in-part of application No. 14/535,818, filed on Nov. 7, 2014, now Pat. No. 9,440,771.

(51) Int. Cl. F16L 1/036; B65D 19/04; B65D 19/20; B23K 37/053; B65D 19/44; F16L 1/028; F16L 1/06; B65D 19/00; B65D 19/14

(52) U.S. Cl. CPC F16L 1/036; B65D 19/0002; B65D 19/04; B65D 19/20; B65D 19/14; B65D 19/44; F16L 1/028; F16L 1/06; B23K 37/053; B65D 2519/00019; B65D 2519/00815; B65D 2519/00567; B65D 2519/0086; B65D 2519/00562; B65D 2519/00029; B65D 2519/00064; B65D 2519/00169; B65D 2519/00054; B65D 2519/00159; B65D 2519/00268; B65D 2519/00273; B23K 2201/10

(57) ABSTRACT

A method of making a pipeline, including providing a beam or support segment having a biodegradable core made from cellulose fiber, providing pipeline segments or sections, supporting aligned ends of the pipeline segments or sections above a surface using the beam or support segment; and connecting the supported aligned ends of the pipeline segments or sections together to form the pipeline, and a support segment for constructing and staging a pipeline.

### CROSS-REFERENCE TO RELATED APPLICATIONS

This is a continuation-in-part application of U.S. patent application entitled “SUPPORT ASSEMBLY AND COMPONENTS THEREOF”, application Ser. No. 14/535,818, filed on Nov. 7, 2014 and U.S. patent application entitled “SUPPORT UNIT”, application Ser. No. 14/613,472, filed on Feb. 4, 2015, which applications are incorporated by reference herein.

### FIELD OF THE INVENTION

This invention also relates to a method of constructing a pipeline, and method of making biodegradable beams or support segments.

Further, this invention relates to an assembly of components for supporting a weighty object such as a large metal pipe, and more particularly to such an assembly in which the components thereof are simple in design, formed of comparatively inexpensive materials, lightweight, easily fabricated, easily transportable and manually handled, capable of sustaining heavy loads and readily disposable after effective usage.

This invention further relates to a support unit and more particularly to a unit functional in supporting a heavyweight tubular member, which is lightweight and manually transportable.

### BACKGROUND OF THE INVENTION

In the oil and natural gas industries, it is a common practice to transmit fluid commodities from one site to another. Such practice generally consists of forming a trench between such sites, providing and placing a transmission pipeline in such trench and filling such trench with excavated soil to permanently bury such pipeline. Typically, following the formation of such trench, segments of such pipeline are transported to successive locations along and adjacent a trench line, mounted on skids or pallets in end-to end relation, welded together, transferred into the adjacent, opened trench and covered with earth to provide a buried transmission pipeline.

In the prior art, such skids or pallets used to support pipeline segments have consisted of stacks of solid, wooden beams. Typically, such beams have been formed and stored in warehouses or other storage sites distant from such pipeline routes, transported from distant storage sites to a location proximate a pipeline trench, repositioned by local machinery at spaced intervals along the opened trench, assembled at such sites onto skids or pallets for supporting the ends of successive sets of pipes to be welded together, disassembled upon welding and loading the welded segments into the trench and either transported to a successive site along the pipeline route to be used again or transported to a local storage area or a distant storage facility for further usage as described.

Such practice of use of such skid or pallet components has been found to be uneconomical. Initially, it is to be noted that such components being formed of wood are expensive. Such cost further is increased by the costs of storing, transporting to and from assembly storage and use sites, handling at use sites and discarding damaged or worn components. Accordingly, the principal object of the present invention is to provide a component for the purpose as described which is more economical to produce and use than predecessor components.

Further, in the oil and gas producing industries, it typically is required to transport product from a production site to an end use or refinement site. In providing for such transmission, typically, a right-of-way is acquired between sites, a trench is formed along such right-of-way, pipeline segments are positioned in end-to-end relation along such trench and welded together, and then the trench is filled to cover a completed pipeline. In positioning such pipeline segments in a trench and welding them together, various support structures are used to facilitate the welding operation. Typically, wooden beams are used which often are stored at facilities distant from intended pipeline routes, transported through the use of vehicle from such facilities to drop-off locations along a pipeline trench, transported to spaced locations along such trench and then lowered into the trench for positioning an end portion of a pipeline segment to be welded to an aligned segment. Although various mechanical machines and devices are used to haul such beams, they often are transported manually which often is burdensome in view of their considerable weight. Upon completion of each welding routine, such wooden beams are required to be removed from their support sites and moved to sequential support sites, which is done manually. Upon completion of a pipeline burial operation, such support beams, to the extent they continue to be serviceable, are returned to a distant storage site for future usage, requiring additional mechanical and manual handling.

In view of the foregoing, it is the principal object of the present invention to provide a means which is sufficiently sturdy to support a portion of a heavy pipeline segment, lightweight to facilitate mechanical and manual transporting from a remote storage site to a pipeline trench site and of a construction conducive to suitable disposal following such use.

### SUMMARY OF THE INVENTION

The presently described subject matter is directed to a method of assembling a pipeline, comprising or consisting of providing a beam or support segment having a biodegradable core made from cellulose fiber, providing pipeline segments or sections, supporting aligned ends of the pipeline segments or sections above a surface using the beam or support segment, and connecting the supported aligned ends of the pipeline segments or sections together to form the pipeline.

Preferably the method includes covering the biodegradable core with a covering. More preferably the covering is a biodegradable covering.

Preferably the covering is a ply material.

Preferably the biodegradable covering is a biodegradable coating.

Preferably the biodegradable core is made of plies of material connected together using a biodegradable adhesive.

Preferably the biodegradable core is made of biodegradable fiberboard.

Preferably the biodegradable core is made of biodegradable fiberboard, and the method includes cutting a stock fiberboard material to make the biodegradable core.

More preferably the biodegradable core is made of biodegradable fiberboard, and the method includes cutting a stock fiberboard material to make the biodegradable core, and enveloping the biodegradable core with a covering. Preferably the enveloping includes wrapping the biodegradable core with a covering.

The presently described subject matter is also directed to a method of assembling a pipeline, comprising or consisting of providing a beam or support segment having a biodegradable core made from cellulose fiber, providing pipeline segments or sections, supporting aligned ends of the pipeline segments or sections above a surface using the beam or support segment, and connecting the supported aligned ends of the pipeline segments or sections together to form the pipeline, wherein the beam or support segment is multiple beams or support segments.

Typically the methods of the invention include stacking a plurality of the beams or support segments to support the aligned ends of the pipeline segments or sections.

Typically the methods of the invention for assembling a pipeline connect the supported aligned ends of the pipeline segments or sections together to form the pipeline by a method including welding the supported aligned ends of the pipeline segments or sections.

Typically the methods of the invention for assembling a pipeline connect the supported aligned ends of the pipeline segments or sections together to form the pipeline by a method including coupling the supported aligned ends of the pipeline segments or sections using mechanical couplers.

Typically the methods of the invention for assembling a pipeline include digging a trench for accommodating the pipeline, wherein preferably the pipeline is assembled adjacent to or within the trench.

The presently described subject matter is also directed to a method of assembling a pipeline, comprising or consisting of making a beam or support segment having a biodegradable core made from cellulose fiber, providing pipeline segments or sections, supporting aligned ends of the pipeline segments or sections above a surface using the beam or support segment, and connecting the supported aligned ends of the pipeline segments or sections together to form the pipeline, further comprising storing multiple beams or support segments at a site distant from the trench, transporting the multiple beams or support segments to a site of the trench, and assembling the beams or support segments to support the aligned ends of the pipeline segments or sections.

Typically the methods of the invention for assembling a pipeline further include recycling used beams or support segments.

However, the presently described methods of assembling a pipeline, also encompass disposing used beams or support segments within the trench accommodating the pipeline. Preferably, used beams or support segments are disposed within the trench accommodating the pipeline and the pipeline buried along with the used beams or support segments within the trench.

The presently described subject matter is also directed to a method of assembling a pipeline, comprising or consisting of making a beam or support segment having a biodegradable core made from cellulose fiber, providing pipeline segments or sections, supporting aligned ends of the pipeline segments or sections above a surface using the beam or support segment, and connecting the supported aligned ends of the pipeline segments or sections together to form the pipeline, wherein the biodegradable core is made of plies of material connected together using a biodegradable adhesive, and wherein the biodegradable adhesive comprises one of a group consisting of Dexatrin, starched based glues, Casein glues or Mucilage, and the coating may consist of natural rubber, latex, India rubber, polyisoprene, polymers of isoprene, polyisoprene elastomers, polymer cis-1, 4-polyisoprene, 2-octylcyanoacrylate, cyanoacrylate esters and vinyl identified by CAS numbers by the chemical abstracts Service, a division of the American Chemical Society.

The presently described subject matter is also directed to a method of assembling a pipeline, comprising or consisting of making a beam or support segment having a biodegradable core made from cellulose fiber, providing pipeline segments or sections, supporting aligned ends of the pipeline segments or sections above a surface using the beam or support segment, and connecting the supported aligned ends of the pipeline segments or sections together to form the pipeline, including covering the biodegradable core with a covering, wherein the covering is a biodegradable covering, wherein the biodegradable coating comprises, a natural latex.

The presently described subject matter is directed to a support segment for use in construction and staging a pipeline, the support segment comprising a pair of spaced apart biodegradeable beams constructed of plies of cardboard adhered together; and a cover enclosing the pair of spaced apart biodegradeable beams.

The presently described subject matter is directed to a support segment for use in construction and staging a pipeline, the support segment comprising a pair of spaced apart biodegradeable beams constructed of plies of cardboard adhered together; and a cover enclosing the pair of spaced apart biodegradeable beams, further comprising one or more cross-beams connecting together the pair of spaced apart biodegradeable beams. Preferably comprising a pair of spaced apart cross-beams connecting together the pair of spaced apart biodegradeable beams defining an opening surrounded by the beams.

Typically the one or more cross-beams is centered relative to each of the pair of spaced apart biodegradeable beams defining a pair of spaced apart openings surround by the beams.

The present invention overcomes and improves upon the shortcomings and deficiencies of the prior art by providing a support assembly for a weighty object such as a heavy metal pipeline segment, which includes a base tier including a pair of spaced beams; and at least one upper tier including a pair of spaced beams disposed angularly relative to and supported on a set of beams of a lower tier, wherein each of such beams is formed of a set of plies of corrugated cardboard secured together with a biodegradable adhesive, and such set of plies is coated with a biodegradable material. In the various embodiments of the invention, at least one additional beam may be provided in each tier of such assembly, the beams of each tier of such assembly are disposed at an angle, preferably a right angle to the beams of a successive tier of such assembly, such beams may be provided with two or three recesses on one or both upper and lower surfaces for receiving portions of a beam of a successive tier in locking engagement therewith and a beam in an uppermost tier may be provided in a center position with a depression for accommodating the placement and resting of an elongated member such as a pipeline segment.

In a still further embodiment of the invention, each tier of a stacked set of support components includes a rectangularly configured member formed of a set of plies of corrugated card board secured together with a biodegradable adhesive, coated with a biodegradable coating and or degradable coating, with those components intended for an upper tier being provided with an elongated recess having a curved cross-sectional configuration for receiving and resting a tubular member such as a pipeline segment.

Another object of the present invention is achieved by means of a lightweight, manually transportable unit, effectual in supporting a heavyweight tubular member, providing a pair of spaced beams each formed of a set of plies of corrugated cardboard and having a recess with a curved cross-sectional configuration, aligned with the recess of the other of such beams; and an enclosure formed of planar and curved panels formed of corrugated cardboard encompassing such pair of spaced beams, wherein the plies of such beams are secured together and the enclosure encompassing the pair of spaced beams is secured to said beams by a biodegradable adhesive. In a preferred embodiment of invention, the enclosure is provided with a biodegradable coating, and one or two additional beams interconnecting the two spaced beams is provided to enhance the rigidly of the unit.

### BRIEF DESCRIPTION OF THE DRAWINGS

FIG. 1 is a perspective view of a first embodiment of the invention consisting of an assembly functional to support a portion of a large pipe segment.

FIG. 2 is a clear perspective view of the assembly shown in FIG. 1 supporting a pipe segment.

FIG. 3 is a perspective view of another embodiment of the present invention similarly functional to support a portion of a large pipe segment as shown in FIG. 1.

FIG. 4 is a perspective view of a component beam utilized in forming the support assembly shown in FIGS. 1 and 2 or 3.

FIG. 5 is a perspective view an alternate component beam that may be utilized in forming a support assembly as shown in FIGS. 1 and 2 or 3.

FIG. 6 is a perspective view of a component beam utilized in forming the support assembly shown in FIG. 3.

FIG. 7 is a perspective view of an alternate component beam that may be utilized in forming the a support assembly shown in FIG. 3.

FIG. 8 is an enlarged sectional view taken along lines 8-8 in FIG. 6, illustrating the composition of the internal structure of the beam shown in FIG. 6 and comparable to the compositions of the structure of each of the component beams utilized in any of the disclosed beam assemblies.

FIG. 9 is a perspective view of another embodiment of the invention consisting of another assembly functional to support a portion of a large pipeline segment.

FIG. 10 is a perspective view of a component utilized in forming a tier of the assembly shown in FIG. 9.

FIG. 11 is a perspective view of a component similar to the component shown in FIG. 10, provided with an elongated recess having a curved cross sectional configuration which may be provided in an upper tier of an assembly as shown in FIG. 9 to receive and support a portion of a pipeline segment.

FIG. 12 is a vertical partial longitudinal cross-sectional detail view of the core of the support segment shown in FIG. 10.

FIG. 13 is a partial exploded detailed view showing the detailed construction or arrangement of the core of the support segment shown in FIG. 12.

FIG. 14 is a perspective view showing a stack of the various support segments shown in FIG. 10, 16-18, or 20-22.

FIG. 15 is a perspective view of another support segment.

FIG. 16 is a vertical longitudinal view of a further support segment.

FIG. 17 is a vertical longitudinal view of an even further support segment.

FIG. 18 is a vertical longitudinal view of another further support segment.

FIG. 19 is a perspective view of a stack of round support segments.

FIG. 20 is a partial broken away perspective view of another support segment.

FIG. 21 is a partial broken away perspective view of a further support segment.

FIG. 22 is a partial broken away perspective view of an even further support segment.

FIG. 23 is a perspective view showing the support assembly system for constructing and staging a pipeline.

FIG. 24 is a diagrammatic view showing the making of a support segment.

FIG. 25 is a diagrammatic view showing the making of another support segment.

FIG. 26A is a diagrammatic view showing making a support segment.

FIG. 26B is a diagrammatic view showing providing pipeline segments or sections, for example, to the construction site of the pipeline.

FIG. 26C is a diagrammatic view showing lifting the pipeline segments or sections and supporting same on stacks of support segments.

FIG. 26D is a diagrammatic view showing the pipeline segments or sections welded together to form the pipeline.

FIG. 27 is a perspective view of an embodiment of the invention functional in supporting a heavy pipeline segment as illustrated in broken lines.

FIG. 28 is an end view of the unit shown in FIG. 27 having the enclosure portion removed.

FIG. 29 is a perspective view of the segment shown in FIG. 28.

FIG. 30 in an enlarged, fractional view of a corner portion of the unit shown in FIG. 27, having portions of the end and top panels of the enclosure portion removed to reveal an end portion of one of the beam members constituting a component thereof.

FIG. 31 is a view similar to the view shown in FIG. 2, further provided with top and bottom panels and an end panel of the enclosure portion of the unit.

FIG. 32 is a partial, perspective view of another embodiment of the invention, having top and end panels of the enclosure removed, and prior to the formation of one or more recesses in the beam segments thereof for partially providing a seating surface for a tubular member.

FIG. 33 is a view similar to the view shown in FIG. 6 provided with a pair of spaced, interconnecting beams, also prior to the formation of one or more recesses in the beam segments thereof for partially providing a seating surface for tubular member.

### DETAILED DESCRIPTION OF PREFERRED EMBODIMENTS

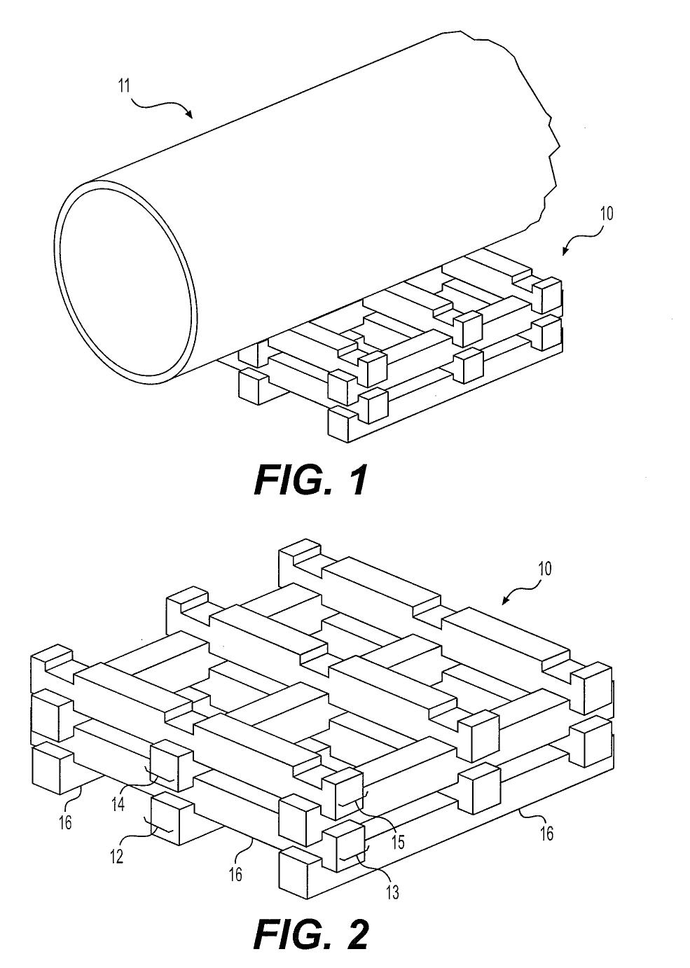

FIGS. 1 and 2 of the drawings show a first embodiment of the invention including an assembly 10 supporting a portion of a pipeline segment 11, providing a base tier 12 and a set of upper tiers 13, 14 and 15, each provided with a set of beams 16 as shown in FIG. 4. As best shown in FIG. 4, each beam 16 is generally rectangularly configured with an elongated rectangular surface 17 provided with a pair of spaced recesses 18 and 19 disposed adjacent the ends thereof and a centrally disposed recess 20 between recesses 18 and 19. Base tier 12 of assembly 10 includes a set of three parallel, spaced beams 16, with the recesses 18, 19 and 20 of each of such beams aligned with comparable recesses in each of the other two beams of such tier. Each of the upper tiers 13, 14 and 15 includes a set of three parallel, spaced beams 16, with the recesses 18, 19 and 20 of each of such beams aligned with comparable recesses in each of the other two beams of such tier, with each of such beams being disposed at a right angle relative to a beam in a lower tier and received in and seated in an aligned set of recesses in a set of beams of a lower tier.

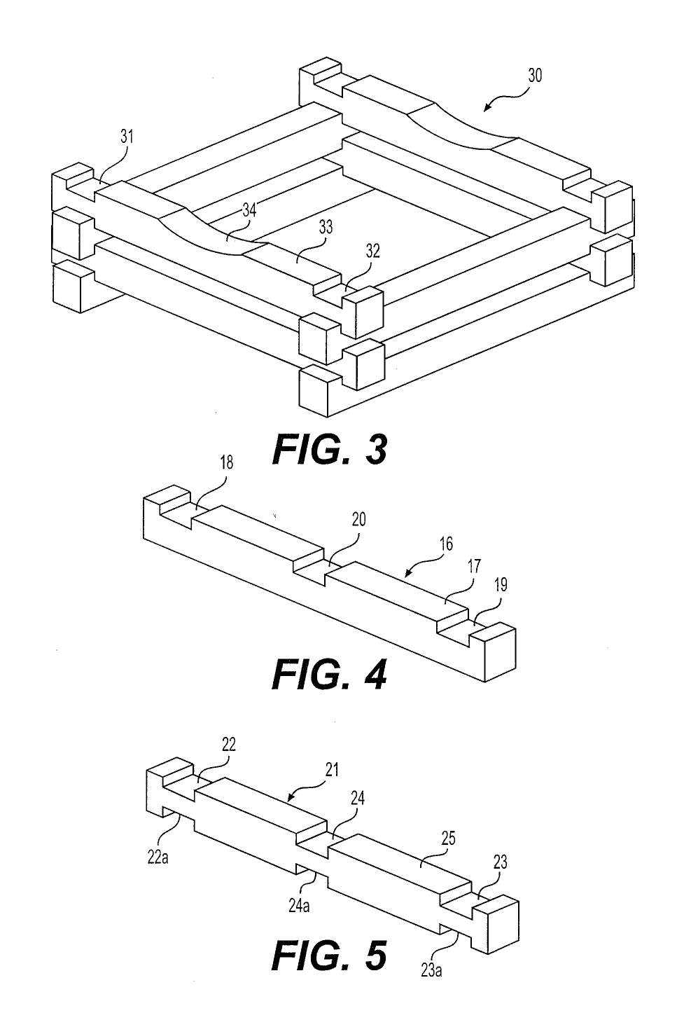

In lieu of a set of beams as shown in FIG. 4 in forming an assembly as shown in FIGS. 1 and 2, a beam 21 as shown in FIG. 5 may be used. Such beam is provided with a first set of recesses 22, 23 and 24 in an upper surface 25, comparable to recesses 18, 19 and 20 of beam 16, and a second set of recesses 22a, 23a and 24a in an opposite surface, comparable and aligned, respectively, with recesses 22, 23 and 24 in the upper surface thereof. A plurality of beams 21 may be assembled together as described with respect to beam 16 to form an assembly similar to that shown in FIG. 3. In such modified assembly, the recesses on the underside of beams 21 are aligned to receive portions of the beams in upper and/or lower beams to provide a greater rigidity to the assembly.

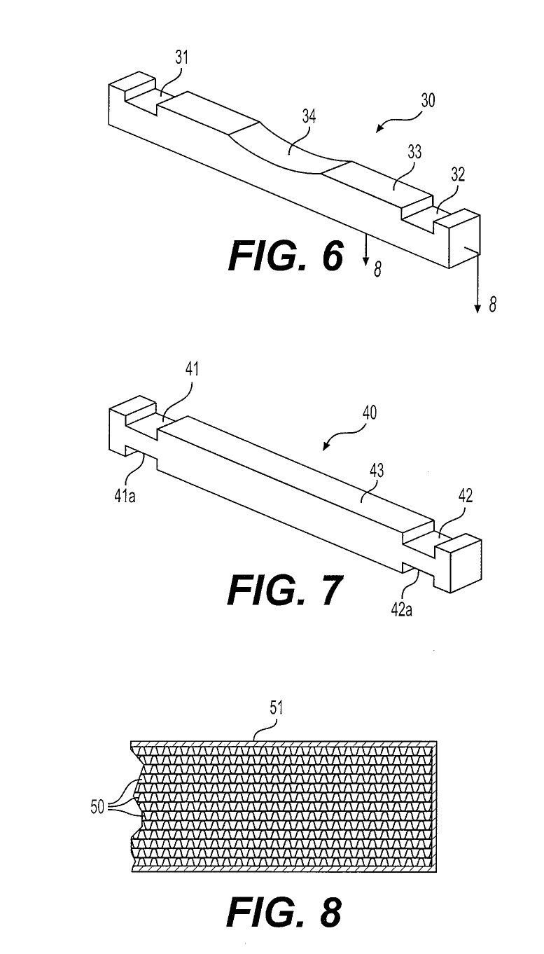

Referring to FIG. 3 of the drawings, there is disclosed a perspective view of a further embodiment of the invention. Such embodiment is similar to the embodiment shown in FIG. 2 but includes only two beams per tier. Such beams include a configuration as provided in a beam 30 shown in FIG. 6 and a configuration as provided in a beam 40 shown in FIG. 7, Beam 30 is configured similarly to the configuration of beam 16 shown in FIG. 4 including a pair of spaced recesses 31 and 32 in a surface 33, with a curved, shallow depression 34 centered between recesses 31 and 32 in lieu of a recess as provided in beam 16. Beam 40 is configured similarly to the configuration of either beam 16 or 21, omitting any centered recess or depression and providing a spaced set of recesses 41a and 42a in an opposite surface, each aligned with a recess 41 or 42, respectively. Beams 30 and 40 may be assembled in a manner as described with respect to beams 20 and 21 to form an assembly as shown in FIG. 3 with two spaced beams in each tier, the beams of each upper tier being disposed at right angles to the beams of a successive tier and either of the beams being provided in the uppermost tier with such uppermost beams preferably consisting of beam 30 with the depressions 34 being aligned to provide a resting surface for a portion of a pipeline segment.

Referring to FIG. 8, each of the beams described is formed of a plurality of plies 50 of corrugated cardboard, secured together with a biodegradable adhesive and coated with a biodegradable material providing a durable casing. The adhesive may consist of Dexatrin, starched based glues, Casein glues or Mucilage. The coating may consist of natural rubber, latex, India rubber, polyisoprene, polymers of isoprene, polyisoprene elastomers, polymer cis-1, 4-polyisoprene, 2-octylcyanoacrylate, cyanoacrylate esters or vinyl identified by CAS numbers by the Chemical Abstracts Service, a division of the American Chemical Society.

In the use of the beams as described, they may be initially stored at an offsite location, manually loaded on vehicles and transported to selected use sites, manually unloaded and stacked at such selected use sites, manually transferred to selected sites along a pipeline route and assembled as described for mounting a pipeline segment, disassembled after removal of the pipeline segment possibly shredded and disposed of either by burial or other means upon ineffectiveness or deterioration in use. Such construction, handling and disposition of such beams provides not only for a minimal cost of production of such beams but in a facility and low cost of usage thereof. The fabrication of such beams provides a low cost, the reduced weight thereof permits manual handling thereof and the disposal aspect thereof eliminates further handling and transportation thereof, substantially reducing the cost in the use of such beams.

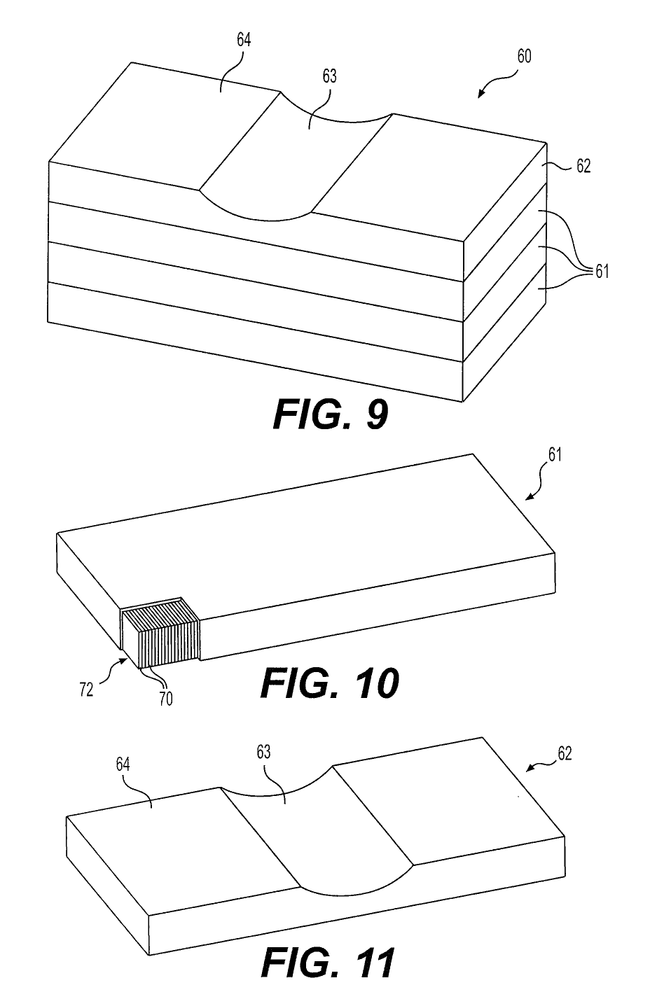

Referring to FIGS. 9 through 10 of the drawings, there is shown another embodiment of the invention which consists of an assembly 60 comprising a stack of one or more lower tier support segments 61 each configured as shown in FIG. 10 and an upper tier segment 62 configured as shown in FIG. 11. Each lower tier segment 61 is rectangularly configured, preferably measuring 30 inches wide, 48 inches long and 6 inches thick, formed of a biodegradable material. It includes a set of plies of corrugated cardboard adhesively secured together, coated about the periphery thereof, Such adhesive and coating materials are similar to those used with respect to the previously described embodiments of the invention.

Each upper tier segment 62 is configured and constructed similarly to segment 61 in terms of width, length, thickness and internal construction, and further is provided with a curved recess 63 in a planar surface 64 thereof, extending from one long edge thereof to an opposed edge thereof. Such recess is positioned and configured for effectively receiving and supporting a portion of a pipeline segment, when mounted on a stack of lower tier segments 61 as shown in FIG. 9. As partially shown in FIG. 10, the internal construction of each segment 61 and 62 is similar to the internal construction of each of the components of the previously described embodiments as shown in FIG. 8.

The support segments 61 and 62 are usable similarly to the use of the beam members provided in the aforementioned embodiments, are intended to be stacked and stored at an off-site location, transported to one or more sites along a pipeline trench and manually unloaded, and then manually hauled to spaced sites along and adjacent the trench where they are stacked to provide a support for end portions of pipes to be welded together. Each of such stacks would consist of a selected number of lower tier support segments 61 and an upper tier segment 62 positioned on the uppermost segment 61 with the length of recess 63 therein disposed substantially parallel to the trench.

The benefits of the segments as described are that they are simple in design, simple and comparatively inexpensive to produce, easily and economically transportable from an offsite location to an end use site, and lightweight allowing workmen to manually lift, carry, stack and disassemble repeatedly.

From the foregoing detailed description, it will be evident that there are a number of changes, adaptations and modifications of the present invention that come within the province of those having ordinary skill in the art to which the present invention pertains. However, it is intended that all such variations not departing from the spirit of the invention be considered as within the scope thereof as limited solely by the following claims.

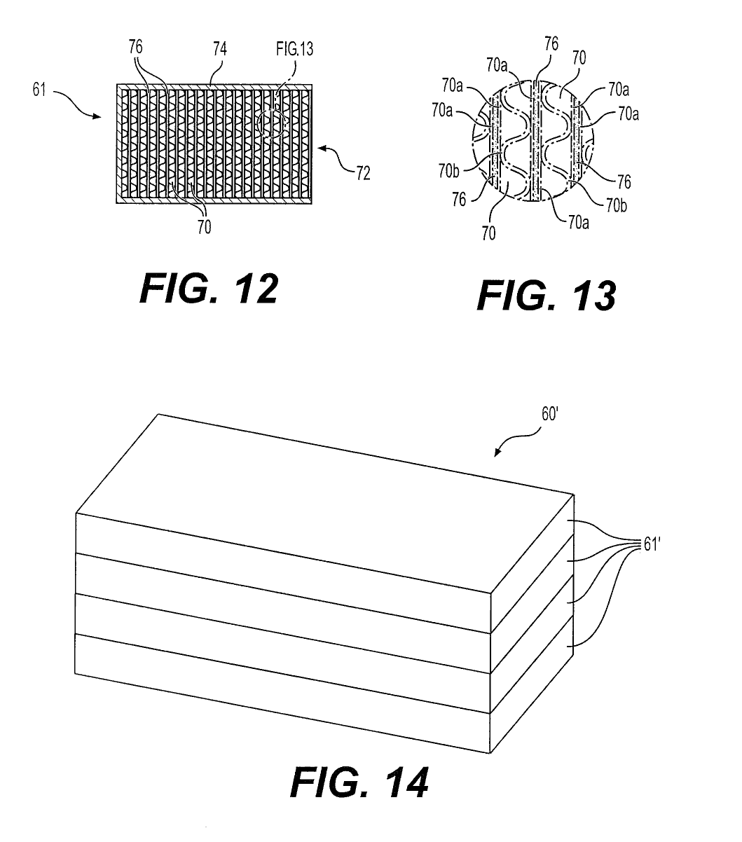

Referring to FIG. 12 of the drawings, each of the support segments 61 and 62 can be formed of a plurality of plies 70 of corrugated cardboard, secured together with one or more adhesives (e.g. biodegradable adhesive) to form a core 72. The core 72 is at least partially enclosed (e.g. one or more exposed portions or encapsulated) with an outer covering 74. For example, the outer covering 74 can be a coating, laminate, wrap, molded layer, or combination thereof. The material (e.g. biodegradable material) of the outer covering 74, for example, can be selected to provide a durable outer covering 74 while also being biodegradable.

The adhesive, for example, can be applied to provide adhesive layers 76 located between adjacent plies 70, as shown in detail in FIG. 13. Specifically, each ply 70 comprises a pair of sheets 70a sandwiching a corrugated layer 70b.

The adhesive for adhering the plies 70 together can be Dexatrin, starched based glues, Casein glues or Mucilage. The coating can comprise or consist of natural rubber, latex, India rubber, polyisoprene, polymers of isoprene, polyisoprene elastomers, polymer cis-1, 4-polyisoprene, 2-octylcyanoacrylate, cyanoacrylate esters or vinyl identified by CAS numbers by the Chemical Abstracts Service, a division of the American Chemical Society.

The assembly 60′ shown in FIG. 14 comprises multiple (e.g. three (3)) segments 61′ stacked one on top of the other. The segments 61′ can be stacked free standing (i.e. without any connection therebetween), or can be stacked and connected together using adhesive between segments 61′, using double sided tape between segments 61′, using tape on one or more edges of the segments 61′, and/or using a mechanical fastener (e.g. one or more metal stakes, one or more metal or nylon bands wrapping around assembly 60′, one or more clamps, etc.).

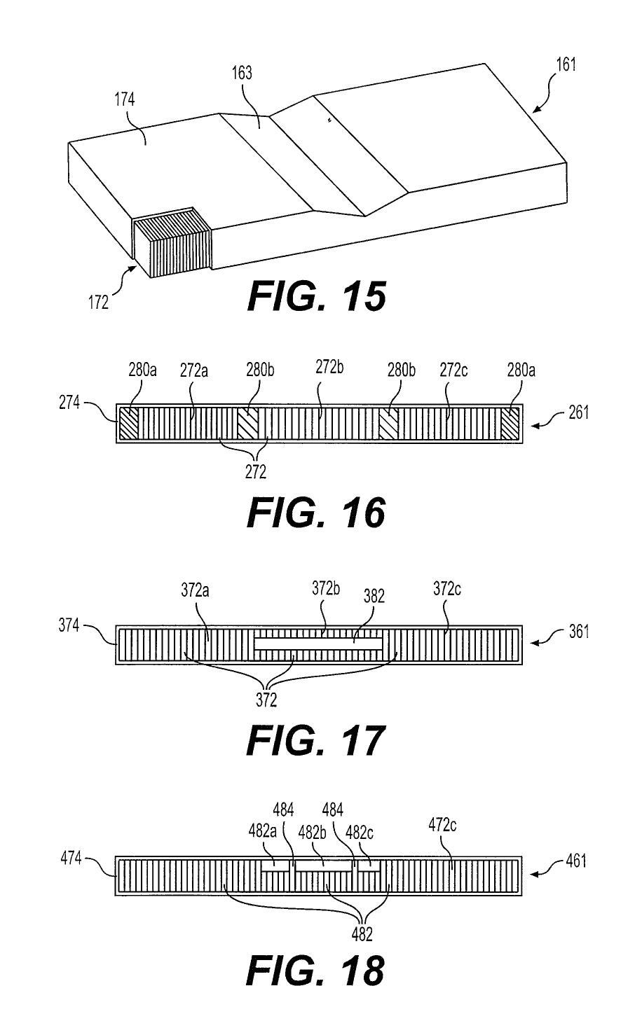

Another segment 161 comprising a core 172 and a covering 174 is shown in FIG. 15. This segment 161 includes an upside down triangular-shaped recess 163 configured to prevent a pipe from rolling off center therefrom when supporting the pipe for welding or staging.

The core 172 can be made of multiple plies adhered together like segment 61 shown in FIG. 13. Alternatively, the core 172 can be made of one or more honeycomb panels such as manufactured by Packaging Corporation of America (PCA), 1955 West Field Court, Lake Forest, Ill. 60045 (800-456-4725) or HEXACOMB panels manufactured by Hexacomb Corporation, 1650 Lake Cook Road, Suite 400, Deerfiled, Ill. 60015 (800-323-9161).

The outer covering 174 can be a coating, laminate, panel, wrap (e.g. Tyvek), shrink wrap, or other suitable covering material (e.g. biodegradable) applied to the core 172. For example, the outer covering 174 is a fiberboard wrap applied to the core 172.

The flat linerboard(s) of the fiberboard can be coated to be waterproof on at least the outside or both outside and inside surfaces. Alternatively, the outer covering 174 can be wrapped with biodegradable sheet material and taped, shrink wrapped, or vacuum sealed.

A further segment 261 is shown in FIG. 16. The segment 261 comprises blocks 280a, 280b spaced apart by three (3) separate cores 272a, 272b, 272c, which can be made of the same or different core materials or panels and assembled together (e.g. adhered together). The blocks 280a, 280b, for example, can be made of wood, hard foam blocks, plastic or composite blocks, hard plastic honeycomb blocks, or other suitable block material and configuration to resist compression. The inner blocks 280b are located inside the segment 261, and capture and maintain the pipe centered on top of the segment 61 to prevent the pipe from rolling off therefrom. The blocks 280a are located adjacent to the ends of the segment 261, and prevent the ends of the segment 261 from compressing or crushing to maintain the stability of a stack of these segments 261. The outer covering 274 can be a coating, laminate, panel, wrap (e.g. Tyvek), shrink wrap, or other suitable covering material (e.g. biodegradable) applied to the assembled core

Another further segment 361 is shown in FIG. 17. The segment 361 comprises three (3) separate cores 372a, 372b, 372c assembled together (e.g. adhered together). Alternatively, the core 372 is a single core. A cavity 382 is provided in the core 272b, and configured to collapse or compress when a pipe is centered on top of the segment 361. For example, the cavity 382 can be made before or after assembly of the core 372b (e.g. core 372b is assembled, formed, or machined to provide the cavity 382).

An even further segment 462 is shown in FIG. 18. The segment 461 comprises three (3) separate cores 472a, 472b, 472c assembled together (e.g. adhered together). Alternatively, the core 472 is a single core. Cavities 482a, 482b, 482c are provided in the core 472b, and configured to collapse or compress when a pipe is centered on top of the segment 461. For example, the cavities 482a, 482b, 482c can be made before or after assembly of the core 472b (e.g. core 472b is assembled, formed, or machined to provide the cavity 482). The core 472b includes supports 484 provided to support the outer covering 474 located above the cavities 482a, 482b, 482c from deforming (e.g. bowing) down into the cavities 482a, 482b, 482c during storage or use.

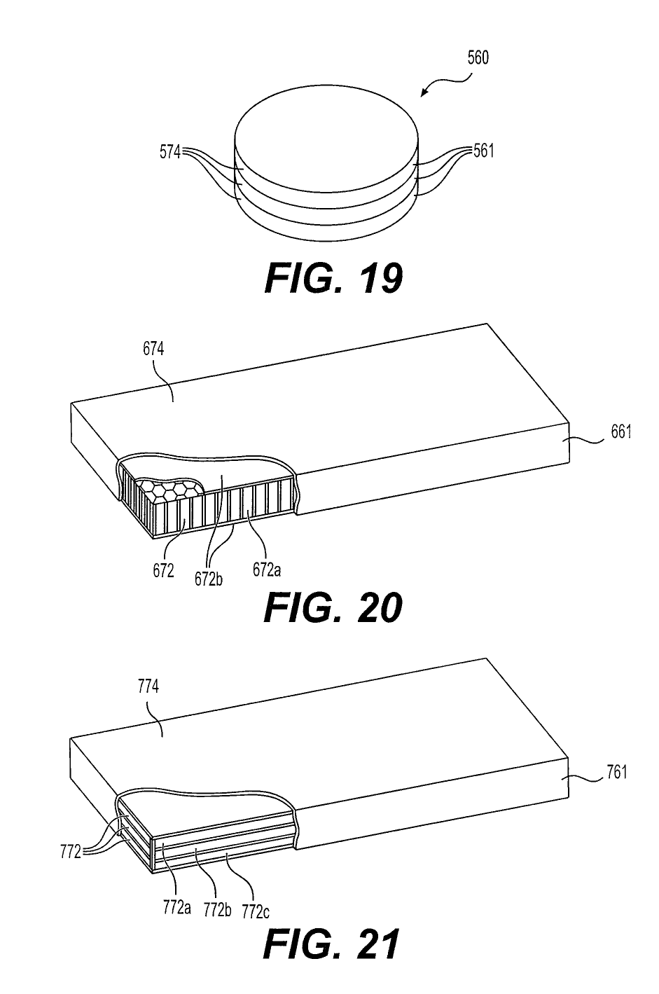

The segments shown and described above have the shape of a rectangular cuboid. However, the segments can have other different shapes such as a cube, parallelepiped, cylinder, pyramid, or other suitable shape and configuration. For example, the assembly 560 comprises three (3) circular-shaped segments 561 stacked on top of each other, as shown in FIG. 19.

The outer covering 574 can be a coating, laminate, panel, wrap (e.g. Tyvek), shrink wrap, or other suitable covering material (e.g. biodegradable) applied to the core 572. For example, the outer covering 574 is a fiberboard wrap applied to the core 572.

Another segment 661 is shown in FIG. 20. The segment 661 comprises a single core 662 made of a honeycomb panel such as manufactured by Packaging Corporation of America (PCA), 1955 West Field Court, Lake Forest, Ill. 60045 (800-456-4725) or HEXACOMB panels manufactured by Hexacomb Corporation, 1650 Lake Cook Road, Suite 400, Deerfield, Ill. 60015 (800-323-9161). The core 672 comprises a honeycomb layer 672a disposed between liner boards 672b

The outer covering 674 can be a coating, laminate, panel, wrap (e.g. Tyvek), shrink wrap, or other suitable covering material (e.g. biodegradable) applied to the core 672. For example, the outer covering 674 is a fiberboard wrap applied to the core 672.

Another segment 761 is shown in FIG. 21. The segment 761 comprises a core 762 made of multiple (e.g. three (3)) honeycomb panels 762a, 762b, 762c such as manufactured by Packaging Corporation of America (PCA), 1955 West Field Court, Lake Forest, Ill. 60045 (800-456-4725) or HEXACOMB panels manufactured by Hexacomb Corporation, 1650 Lake Cook Road, Suite 400, Deerfield, Ill. 60015 (800-323-9161). The panels 762a, 762b, 762c can be unattached, or connected together (e.g. by adhesive, mechanical fastener, tape, band(s), wrapped, etc.).

The outer covering 774 can be a coating, laminate, panel, wrap (e.g. Tyvek), shrink wrap, or other suitable covering material (e.g. biodegradable) applied to the core 772. For example, the outer covering 774 is a fiberboard wrap applied to the core 772.

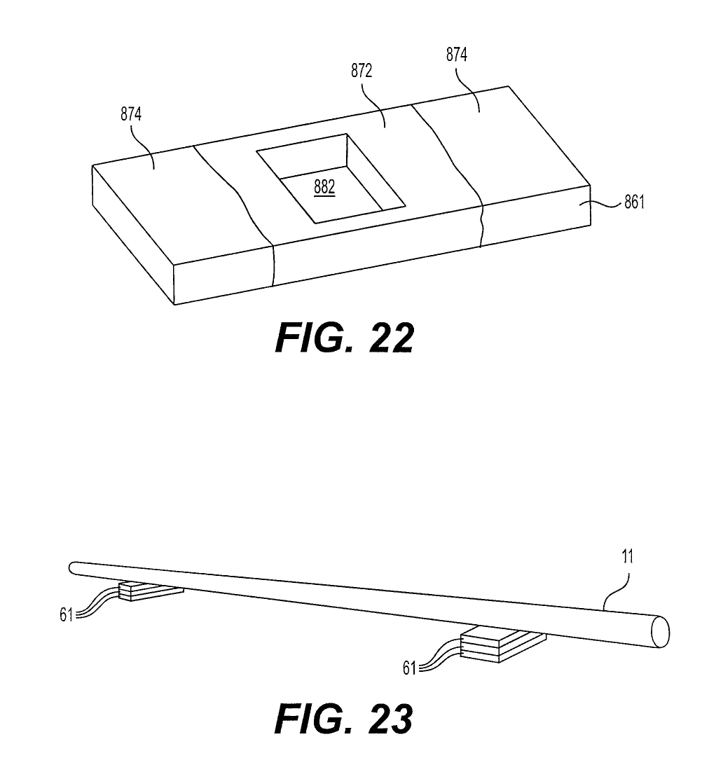

A further segment 861 is shown in FIG. 22. The segment 861 comprises a core 862 made of single or multiple (e.g. three (3)) honeycomb panel(s) 862 such as manufactured by Packaging Corporation of America (PCA), 1955 West Field Court, Lake Forest, Ill. 60045 (800-456-4725) or HEXACOMB panels manufactured by Hexacomb Corporation, 1650 Lake Cook Road, Suite 400, Deerfield, Ill. 60015 (800-323-9161). The panel(s) 862 can be unattached, or connected together (e.g. by adhesive, mechanical fastener, tape, band(s), wrapped, etc.).

The core 872 is provided with a cavity 882 (e.g. rectangular-shaped, square-shaped) as shown in FIG. 22. The cavity 882 is configured to collapse when a pipe is centered on top of the segment 861 to prevent the pipe from rolling off therefrom.

The outer covering 874 can be a coating, laminate, panel, wrap (e.g. Tyvek), shrink wrap, or other suitable covering material (e.g. biodegradable) applied to the core 872. For example, the outer covering 874 is a fiberboard wrap applied to the core 872.

The support segments 61 and 62 are intended to be stacked and stored at an off-site location, transported to one or more sites along a pipeline trench, manually unloaded, and then manually hauled to spaced sites along and adjacent the trench where they are stacked to provide a support for end portions of pipes to be welded together. For example, each of the stacks would consist of a selected number of segments 61, as shown in FIG. 23, stacked one on top of the other, and oriented transverse relative to the pipe 11. Alternatively, the top segment 61 of each stack can be replaced with the segment 62 having the curved recess 63 to accommodate the pipe and prevent the pipe from rolling off the stack. It is noted that other embodiments of the segments shown and described herein can be substituted for the segments 61 and 62.

The benefits of the segments as described and shown are that they are simple in design, simple and comparatively inexpensive to produce, easily and economically transportable from an offsite location to an end use site, and lightweight allowing workmen to manually lift, carry, stack and disassemble repeatedly.

### Method of Making Beams or Support Segments

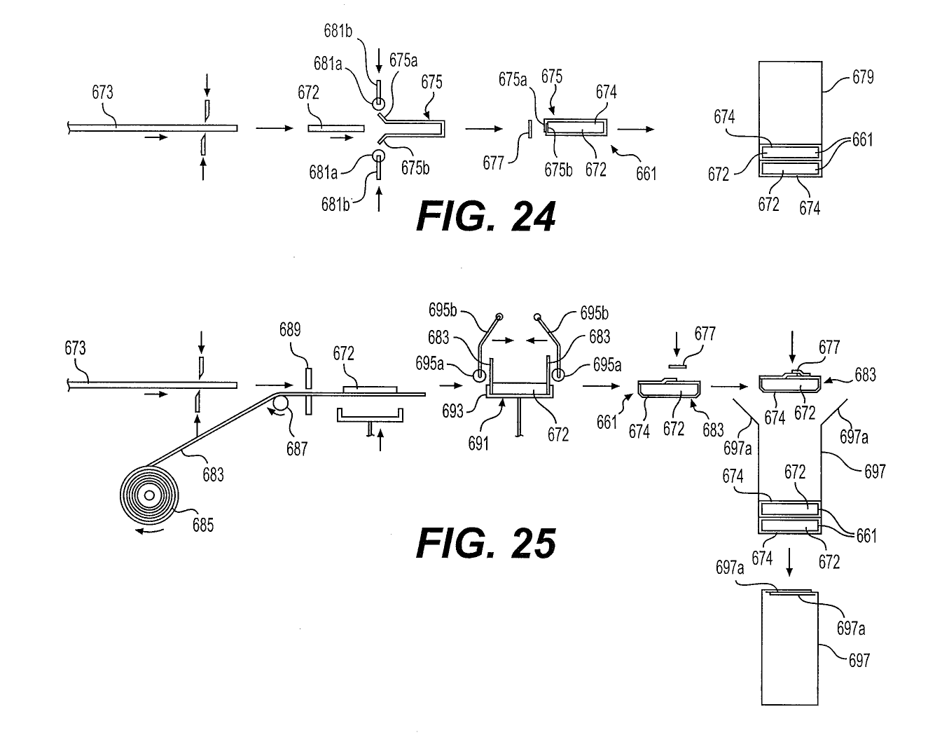

A method of making the segment 661 (FIG. 20) is shown in FIG. 24. The other embodiments of segments described above and shown in the drawings can be made by the same or similar method.

The method begins by providing a supply of honeycomb core sheet material 673, cutting the sheet material 673 into individual cores 672, loading an individual core 672 into a container 675, and closing the container 675 to complete assembly of the segment 661. It is noted that the container 675 acts as the outer covering 674 of the segment in the assembled segment 661.

The container 675, for example, comprises self-sealing flaps 675a, 675b, which seal or adhere together when the flaps 675a, 675b are closed. For example, the outer surface of the flap 675b is provided with a layer of self-adhering adhesive, which adheres to the inner surface of the flap 675a when placed in contact therewith when closing the flaps 675a, 675b of the container 675. Alternatively, or in addition, tape 677 is applied to seal the flaps 675a, 675b closed to complete the assembly of the segment 661.

The container 675 can be sealed, for example, by using a pair of sealing roller 681 sequentially moving towards each other. The sealing rollers 681a mounted on actuator arms 681b can be actuated by hydraulic, pneumatic, mechanical, and/or electrical actuators (not shown).

The assembled segments 661 can be loaded into a container 679 for shipment thereof. For example, the segments 661 are stacked inside the container 679 until full. For example, the container 679 is lowered an increment each time a segment 661 is loaded into the container to stack the segments 661 inside the container 679. The container 679 can have flaps or a cover for closing same. Alternatively, the stacked segments can be shrink wrapped for shipment thereof.

The container 672 can be a fiberboard or cardboard (e.g. corrugated cardboard) container. The other surface, and optionally the inner surface, can be treated or coated to make same waterproof; however, still biodegradable.

Another method of making the segment 661 (FIG. 20) is shown in FIG. 25. The other embodiments of segments described above and shown in the drawings can be made by the same or similar method. This method begins by providing a supply of honeycomb core sheet material 673, cutting the sheet wrapping material 673 into individual cores 672, and wrapping an individual core 672 using a sheet material 683 to complete assembly of the segment 661. It is noted the sheet material 683 acts as the outer covering 674 of the segment in the assembled segment 661.

The sheet wrapping material 683 can be provided with a self-adhering layer provided on one side thereof so that the sheet wrapping material 683 adheres to the outer surface of the core 672 when applied thereto. Alternative, or in addition, tape 677 can be applied to seal the sheet wrapping material 683 when wrapped around the core 672.

The sheet wrapping material 683, for example, can be supplied on a roll 685 to provide a continuous supply thereof. The sheeting wrapping material 683 is unrolled from the roll 685 using a friction roller 687, which drives the sheet wrapping material 683 past a cutter 689 to cut same into individual sheets thereof. The individual sheets of the sheet wrapping material 683 are wrapped around the core 672, for example, using a wrapper 691. For example, the wrapper 691 comprises a U-shaped platen 693 configured to wrap the sheet around the lower edges of the core 672 as shown. A pair of rollers 695a mounted on actuating arms 695b are moved together by hydraulic, pneumatic, mechanical, and/or electrical actuators (not shown) to wrap the sheet material around upper edges of the core 672 to assemble the segment 661.

The assembled segments 661 are lowered into a container 697 for shipping thereof. The container 697 can include self-adhering flaps 697a for sealing same when the flaps 697a are closed. Alternatively, or in addition, the flaps 697 can be taped closed to secured seal the container 697.

### Method of Making a Pipeline

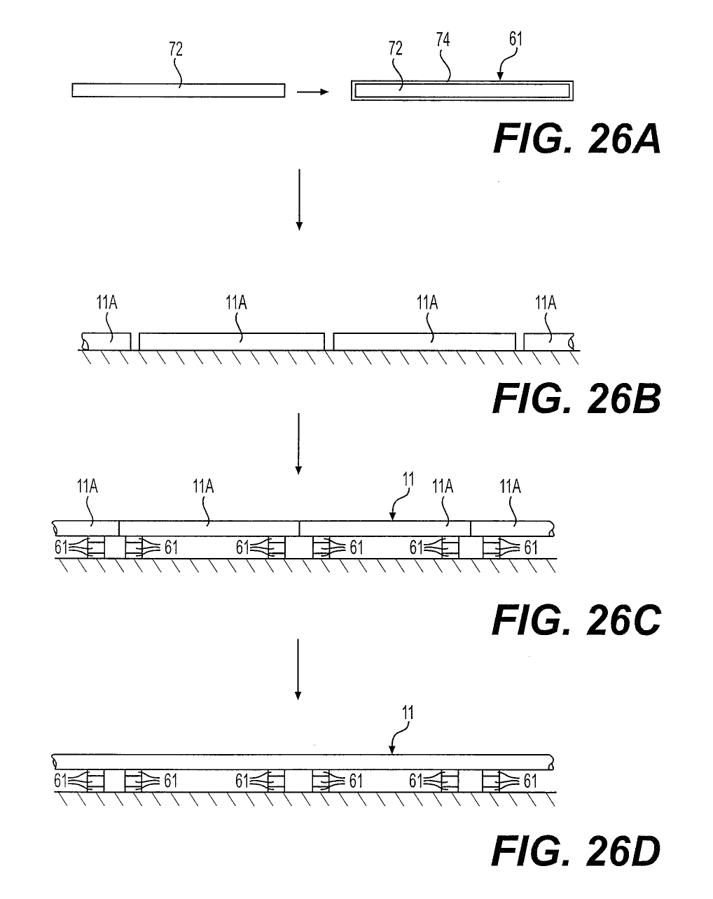

A method of making a pipeline is shown in FIGS. 26A-26D. The method of making a pipeline comprises or consists of the following steps:
1) making a beam or support segment having a biodegradable core made from cellulose fiber;
2) providing pipeline segments or sections;
3) supporting aligned ends of the pipeline segments or sections above a surface using the beam or support segment; and
4) connecting the supported aligned ends of the pipeline segments or sections together to form the pipeline.

For example, a support segment 61 is made by providing core 72 with a covering 74, as shown in FIG. 26A

The pipeline segments or sections 11A are provided to construct the pipeline 11, as shown in FIG. 26B.

The pipeline segments 11A are lifted and stacks of support segments 61 are placed underneath the respective ends of each pipeline segment or section 11A to support same, as shown in FIG. 26C.

The pipeline segments 11A are welded together to form the continuous constructed pipeline 11, as shown in FIG. 26D.

Various example methods of making the beam or support segment is discussed in detail above. The biodegradable core is made of cellulose fiber, for example, cellulose fiber made from wood pulp. For example, the core can be made from cardboard, paperboard, fiberboard, honeycomb board, molded cellulose, or other suitable cellulose fiber board, laminate, molded, composite article, construction or device.

The core can include additional materials to modify the material or physical properties of the core, For example, reinforcing materials (e.g. fibers, fiberglass, ceramic particles, plastic materials, resins) can be added or integrated into the core to increase the tensile, compressive, and/or shear strength of the core while leaving the core still biodegradable.

The method can include additional optional steps, including:
5) storing multiple beams or support segments at a site distant from the trench;
6) transporting the multiple beams or support segments to a site of the trench; and
7) assembling the beams or support segments to support the aligned ends of the pipeline segments or sections.

### Example #1

The beams or support segments are manufactured at a facility to mass produce same and minimize the cost of production. Inventory is stored on site at the manufacturing facility in a warehouse facility, or transported off site to a warehouse facility.

On demand, an order of beams or support segments are transported from the warehouse facility to the site locate of the construction of the pipeline.

A trench is dug in advance of delivery of the beams or support segments. A supply of pipeline segments or sections is delivered and placed in position adjacent to the trench end-to-end. The pipeline segments or sections are lifted one at a time (e.g. by front loader or pipeline equipment), and then workers stack beams or support segments underneath each end of the particular lifted pipeline segment or section.

The workers stack a sufficient number of beams or support segment to elevate the pipeline segment or section to a suitable height (e.g. 2 feet to 5 feet) above the ground adjacent to the trench. This height will allow the workers to connect the ends of the pipeline segments or sections together by welding or by installing mechanical pipe couplers. The lifted pipeline segment or section should be supported somewhat level by the stacked beams or support segment after being lowered onto same.

Once a pipeline segment or section is supported stable by the stacks of beams or support segments, then an adjacent pipeline segment or section is lifted and supported so that the ends of the adjacent pipeline segments or sections are raised and aligned sufficiently to allow welding or coupling of the ends together.

After a sufficient length of pipeline is constructed, the constructed pipeline is lifted off the stacks of beams or support segments and moved laterally and downwardly into the trench by suitable heavy equipment (e.g. front loader, specialized pipeline equipment). The beams or support segments from the stacks can be reused, for example, by placing the beams or support segments spaced apart and underneath positions along the constructed pipeline in the trench. For example, the beams or segments can be used individually or stacked so that constructed pipeline is suitably supported within the trench. For example, the pipeline is positioned and supported level or somewhat level within the trench by the reused beams or support segments. Further the pipeline is supported along its length by the reused beams or support segments so as to prevent inadvertent bending or undesirable stress risers along the length of the constructed pipeline.

The pipeline can be left exposed in the trench or buried using gravel, dirt and/or soil. The used beams or support segments supporting the constructed pipeline in the trench can remain and also be buried along with the constructed pipeline. In addition, the used beams or support segments previously supporting the pipeline being constructed along the trench can be thrown into the trench along the constructed pipeline and buried along with the constructed pipeline to dispose same. Alternatively, or in addition, some or all the used beams or support segments are recycled or reused.

The beams or support segments can be constructed so that the used beams or support segments are biodegradable or recyclable “as is” (e.g. without any further processing steps). Alternatively, the used beams or support segments can require one or more steps to become recyclable. For example, the beams or support segments can be made with biodegradable cores and covered or wrapped in a non-biodegradable covering (e.g. plastic shrink wrapped). In this example, the used beams or support segments are processed to remove the non-biodegradable covering prior to disposal. For example, the covering is cut off or pulled off the biodegradable core prior to disposal thereof.

### Example #2

The same as Example #1, however, the individual beams or support segments bundled by using strapping and/or shrink wrapping or placed in containers or cartons when coming off the production line for bulk shipping thereof.

### Example #3

The same as Example #1, however, the pipeline is constructed within the trench as opposed to being constructed adjacent to the trench.

### Example #4

The same as Example #1, however, the beams or support segments are fastened together using mechanical fastener (e.g. staking stacks), applying adhesive between adjacent beams or support segments, applying outer support (e.g. adhering outer ply or liner to stacks), applying strapping to stacks, and/or applying shrink wrapping to stacks after stacking and prior to supporting the pipeline segments or sections to further stabilize and strengthen the stacks prior to being loaded with the weight of the pipeline segments or sections.

### Additional Embodiments

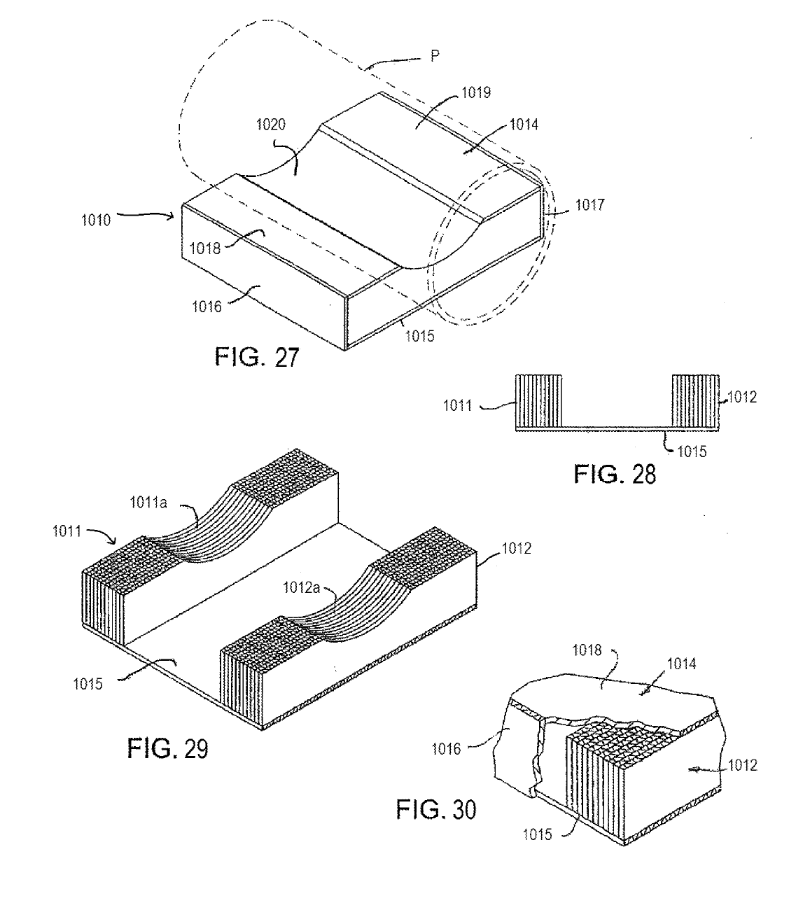

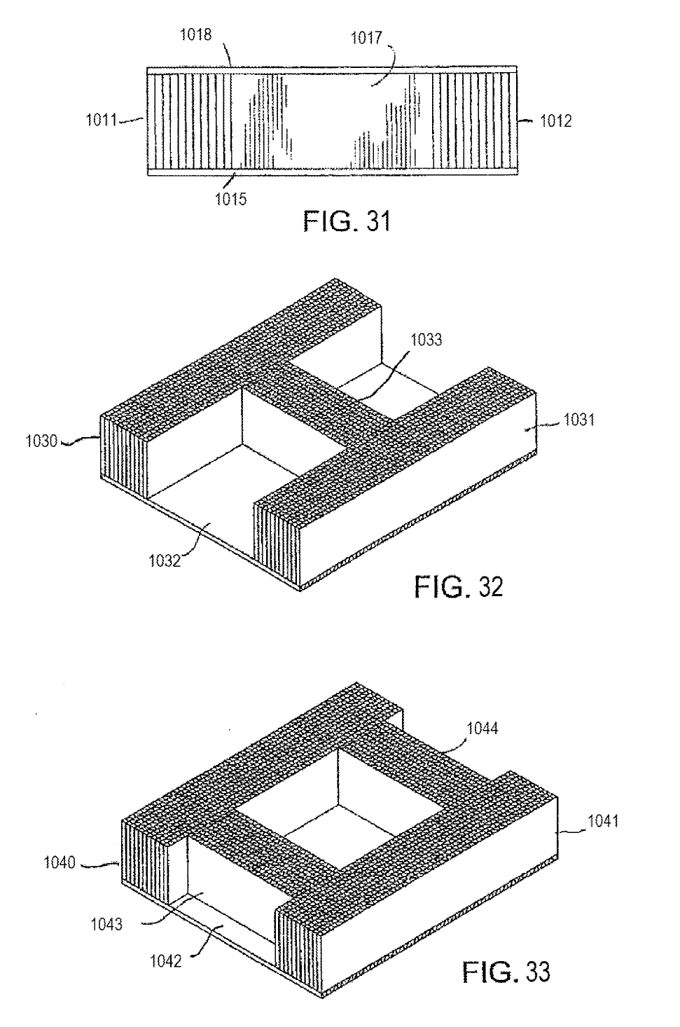

Referring to FIGS. 27 through 33 of the drawings, there is illustrated a unit 1010 embodying the present invention, functional to support a heavy pipeline section P, generally including a pair of substantially similar beams 1011 and 1012 and an enclosure 1014 encompassing such beams. As shown in FIG. 29, such beams are identical in size and construction, each having an elongated, rectangular configuration with a recesses on an elongated upper surface thereof, and being comprised of a set of plies adhesively secured together along the lengths thereof. Enclosure 1014 includes a bottom, rectangularly configured planar panel 1015, a set of end, rectangularly configured panels 1016 and 1017, a set upper, rectangularly configured planar panels 1018 and 1019 are an upper panel 1020 having a curved cross-sectional configuration. Each of such panels is formed of corrugated cardboard.

Each of beams 1011 and 1012 is formed the longer length of enclosure panel 1015, and is provided with a recess 1011a or 1012a, each of which is disposed at the center of its respective beam and is provided with a curved, cross-sectional configuration similar to the cross-sectional configuration of enclosure panel 1020. Each of enclosure panels 1016 through 1019 is formed the shorter length of enclosure panel 1015, and curved panel 1020 similarly is formed such shorter length.

In forming support article 1010, the plies of each of the beam members are first formed and then adhesively secured together along the lengths thereof to form the beam member, and the several planar and the curved panels of the enclosure are formed and cut to required size. The article is then completed by positioning and adhesively adhering beams 1011 and 1012 in spaced relation along the longer sides of enclosure panel 1015, with recesses 1011a and 1012a thereof transversely aligned. End panels 1016 and 1017 are then adhesively adhered to the edges of panel 1015 and the ends of beams 1011 and 1012, curved recess panel 1020 is positioned on and adhesively adhered to the recessed surfaces 1011a and 1012a of the beams and panel members 1018 and 1019 are positioned on and adhesively adhered to the upper end surfaces of the beams to fully enclose the beams with the exception of the outer sides thereof and provide a finished support unit functional to receive and support a pipeline segment P on the surface of enclosure panel 1020.

In the assembly of unit 1010 as described, biodegradable adhesives are used to secure the plies of the beam members together, and to further secure the enclosure panels to the beam members. In addition, upon completion of the assembly process, the enclosure is coated with a biodegradable material. The biodegradable adhesive may consist of Dexatrin, starch based glues, Casein glues and Mucilage. The biodegradeable coating may consist of natural rubber, latex, India rubber, polyisoprene, polymers of isoprene, polyisoprene elastomers, polymer Cis-1, 4-polyisoprene, 2-octylcyanoacrylate, cyanoacrylate esters and vinyl identified by CAS numbers by the Chemical Abstracts Service, a division of the American Chemical Society.

FIG. 32 illustrates a substructure comparable but variant of the substructure of unit 1010 shown in FIG. 29. In such embodiment, beams 1030 and 1031 comparable to beams 1011 and 1012 are disposed in spaced, parallel relation, adhesively secured to enclosure panel 1032 comparable to panel 1015, and is provided with an interconnecting beam 1033 similarly formed of a set of plies adhesively secured together and adhesively secured to bottom panel 1032. Although not shown for purposed of clarity, the beam members collectively or singularly may be provided with a recess provided with a curved cross-sectional configuration similar to either of recesses 1011a and 1011b, disposed either along the length of interconnecting beam 1033 and the center portions of beams 1030 and 1031, or disposed through beam 1033 and parallel to beams 1030 an 1031. Such base structure further would be provided with additional enclosure panels to fully enclose the assembly shown in FIG. 27.

FIG. 33 illustrates an additional substructure also comparable but variant to the substructure of unit 1010 shown in FIG. 29. Such further embodiment is similar to the embodiment shown in FIG. 32 including a pair of spaced, parallel beams 1040 and 1041 adhesively connected to enclosure panel 1040 and a pair of spaced, parallel beams 1043 and 1044 interconnecting beams 1040 and 1041. As provided in the previously described embodiment, a set of spaced, aligned recesses, each provided with a curved cross-section configuration and formed either at the mid points of beam set 1040 and 1041 or beam set 1043 and 1044, and such base structure is provided with additional enclosure panels to fully enclose the assembly shown in FIG. 27.

Any embodiment of the invention as described may readily, effortlessly and rapidly be stored at a facility distant from a pipeline route, manually loaded onto transporting vehicles, transported to selected sites along such pipeline route, manually unloaded and stacked and then manually transported to selected sites along such route and positioned to support an end portion of a pipeline segment to be welded to an abutting pipeline segment. Upon completion of the welding operation, the unit may either be manually transported to another site along the pipeline route and used again to support a pipeline segment to be joined to an adjacent segment, transported back to its storage facility if usable or simply discarded within the pipeline trench to be buried with the pipeline and allowed to degrade.

The units as described have many benefits and are a substantial improvement over currently used pipeline support devices. They are formed of comparatively inexpensively materials, easily fabricated, comparatively lightweight permitting them to be manually transported and handled and biodegradable allowing them to be discarded on site avoiding rehandling and any harmful environmental effect.

From the foregoing detailed description, it will be evident there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

1. A method of making a pipeline, comprising:
providing a beam or support segment having a biodegradable core made from cellulose fiber;
providing pipeline segments or sections;
supporting aligned ends of the pipeline segments or sections above a surface using the beam or support segment; and
connecting the supported aligned ends of the pipeline segments or sections together to form the pipeline.

2. The method according to claim 1, wherein the biodegradable core has a covering.

3. The method according to claim 2, wherein the cover is a biodegradable covering.

4. The method according to claim 2, wherein the covering is a ply material.

5. The method according to claim 3, wherein the biodegradable covering is a biodegradable coating.

6. The method according to claim 1, wherein the biodegradable core is made of plies of material connected together using a biodegradable adhesive.

7. The method according to claim 1, wherein the biodegradable core is made of biodegradable fiberboard.

8. The method according to claim 1, wherein the beam or support segment is multiple beams or support segments.

9. The method according to claim 1, wherein the aligned ends of the pipeline segments or sections are supported above the surface by a lightweight, manually transportable unit, effectual in supporting the pipeline segments or sections comprising:
a pair of spaced said beams each formed of a set of plies of corrugated cardboard and having a recess with a curved cross-sectional configuration, aligned with the recess of the other said beams; and
an enclosure formed of planar and curved panels formed of corrugated cardboard encompassing said pair of spaced beams,
wherein said plies of said beams are secured together and said enclosure encompassing said pair of spaced beams are secured together by a biodegradable adhesive.

10. The method according to claim 1, wherein the aligned ends of the pipeline segments or sections are supported above the surface by a lightweight, manually transportable unit, effectual in supporting a said pipeline segment or section, comprising:
a pair of spaced said beams each formed of a set of plies of corrugated cardboard;
a beam formed of a set of plies of corrugated cardboard interconnecting said spaced beams; and
an enclosure formed of segments of corrugated cardboard encompassing said beams,
wherein one of said spaced and interconnecting beams together, and said interconnecting beam alone, having an elongated recess provided with a curved cross-sectional configuration, and said enclosure includes a curved panel overlying said recess.

11. The method according to claim 1, wherein the aligned ends of the pipeline segments or sections are supported above the surface by a lightweight, manually transportable unit, effectual in supporting a heavyweight tubular member, comprising;
a first pair of spaced said beams each formed of a set of plies of corrugated cardboard;
a second pair of spaced said beams each formed of a set of plies of corrugated cardboard interconnecting said first pair of spaced beams; and an enclosure formed of segments of corrugated cardboard encompassing said beams,
wherein one of said first and second sets of beams having aligned recess provided with curved cross-sectional configurations, and said enclosure includes curved panels overlying said recesses.

12. The method according to claim 3, including stacking the beams or segments to support the aligned ends of the pipeline segments or sections.

13. The method according to claim 1, including welding the supported aligned ends of the pipeline segments or sections.

14. The method according to claim 1, including coupling the supported aligned ends of the pipeline segments or sections using mechanical couplers.

15. The method according to claim 1, including digging a trench for accommodating the pipeline.

16. The method according to claim 15, wherein the pipeline is assembled adjacent to or within the trench.

17. The method according to claim 1, further comprising:
storing multiple beams or support segments at a site distant from the trench;
transporting the multiple beams or support segments to a site of the trench; and
assembling the beams or support segments to support the aligned ends of the pipeline segments or sections.

18. The method according to claim 1, further comprising recycling used beams or support segments.

19. The method according to claim 1, further comprising disposing used beams or support segments within the trench accommodating the pipeline.

20. The method according to claim 19, further comprising burying the pipeline along with the used beams or support segments within the trench.

21. The method of claim 4, wherein said biodegradable adhesive comprises one of a group consisting of Dexatrin, starched based glues, Casein glues or Mucilage, and the coating may consist of natural rubber, latex, India rubber, polyisoprene, polymers of isoprene, polyisoprene elastomers, polymer cis-1, 4-polyisoprene, 2-octylcyanoacrylate, cyanoacrylate esters and vinyl identified by CAS numbers by the chemical abstracts Service, a division of the American Chemical Society.

22. The method according to claim 3 wherein said biodegradable coating comprises, natural latex.

23. A support segment for use in construction and staging a pipeline, the support segment comprising:
a pair of spaced apart biodegradeable beams constructed of plies of cardboard adhered together; and
a cover enclosing the pair of spaced apart biodegradeable beams.

24. The support segment according to claim 23, further comprising one or more cross-beams connecting together the pair of spaced apart biodegradeable beams.

25. The support segment according to claim 23, further comprising a pair of spaced apart cross-beams connecting together the pair of spaced apart biodegradeable beams defining an opening surrounded by the beams.

26. The support segment according to claim 24, wherein the one or more cross-beams is centered relative to each of the pair of spaced apart biodegradeable beams defining a pair of spaced apart openings surround by the beams.
